(19) United States
(12) Patent Application Publication
(10) Pub. No.: US 2008/0009590 A1
(43) Pub. Date: Jan. 10, 2008

(54) PROCESS FOR PREPARING AMINO-FUNCTIONAL SILOXANES

(75) Inventors: Wolfgang Ziche, Burghausen (DE); Robert Lehnert, Dresden (DE); Frank Baumann, Tittmoning (DE); Stefan Altmann, Suenching (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/772,284

(22) Filed: Jul. 2, 2007

(30) Foreign Application Priority Data
Jul. 5, 2006 (DE) 10 2006 031 104.3

(51) Int. Cl. C08F 283/12

(52) U.S. Cl. 525/477

(57) ABSTRACT

The invention relates to a process for catalyzed preparation of amino-functional siloxanes are prepared by a catalyzed process in which organosiloxanes of the general formula

(SiO_{4/2})ₖ(R¹SiO_{3/2})ₘ(R¹₂SiO_{2/2})ₚ(R¹₃SiO_{1/2})_{q}[O_{1/2}H] (II)

are reacted with cyclic silazanes of the general formula

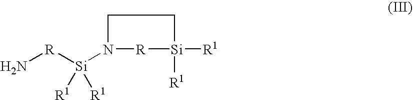

in the presence of Bronsted acids.

### BACKGROUND OF THE INVENTION

1. Field of the Invention

The invention relates to a process for catalyzed preparation of amino-functional siloxanes using cyclic silazanes.

2. Background Art

Aminoalkylpolysiloxanes and aminoalkylsilicone resins are usable in many fields of application, including the preparation of polyimides and polyetherimides. However, the commercial use of these compounds on a larger scale is prevented by relatively expensive preparation processes.

The base-catalyzed equilibration of octamethylcyclotetrasiloxane with bisaminopropyltetramethyldisiloxane is known, as described, for example, in U.S. Pat. No. 5,512,650. This reaction has the disadvantage that the reactant used is the expensive bisaminopropyltetramethyldisiloxane. An additional factor is the long reaction times which are sometimes longer than 10 hours in the equilibration reaction.

WO 2005087842 A1 describes the continuous preparation of amino-functional organosiloxanes. A disadvantage of the process is the need to use complicated continuous process apparatus, for example extruders.

### SUMMARY OF THE INVENTION

An object of the invention is to prepare aminoalkyl-functional siloxanes in a cost-effective and expedient manner. These and other objects are achieved through preparation of aminoalkyl-functional siloxanes through reaction of Si—OH functional siloxanes with a cyclic silazane in the presence of a Bronstead acid catalyst.

### DETAILED DESCRIPTION OF THE PREFERRED EMBODIMENT(S)

The invention thus provides a process for preparing amino-functional organosiloxanes of the general formula

(SiO_{4/2})ₖ(R¹SiO_{3/2})ₘ(R¹₂SiO_{2/2})ₚ(R¹₃SiO_{1/2})_{q}[O_{1/2}SiR¹₂—R—NH₂]ₛ[O_{1/2}H]ₜ (I)

in which organosiloxane(s) of the general formula

(SiO_{4/2})ₖ(R¹SiO_{3/2})ₘ(R¹₂SiO_{2/2})ₚ(R¹₃SiO_{1/2})_{q}[O_{1/2}H]ₜ (II)

are reacted with cyclic silazanes of the general formula

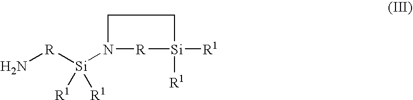

in the presence of Bronsted acids
where
R may be the same or different and is a divalent Si—C— and C—N-bonded, optionally cyano- or halo-substituted C₃-C₁₅-hydrocarbon radical in which one or more nonadjacent methylene units may be replaced by —O—, —CO—, —COO—, —OCO— or —OCOO—, —S— or —NR^{x}— groups and in which one or more nonadjacent methine units may be replaced by —N═, —N═N— or —P═ groups, where at least 3 and at most 6 atoms are arranged between silicon atom and nitrogen atom of the ring,
R^{x} may be the same or different and is a hydrogen atom or an optionally —CN— or halogen-substituted C₁₋₁₀-hydrocarbon radical,
R¹ may be the same or different and is hydrogen atom or a monovalent, optionally —CN—, —NCO—, —NR^{x}₂—, —COOH—, —COOR^{x}—, -halo-, -acryloyl-, -epoxy-, —SH—, —OH— or —CONR^{x}₂-substituted, Si—C-bonded C₁₋₂₀-hydrocarbon radical, or a monovalent, optionally —CN—, —NCO—, —NR^{x}₂—, —COOH—, —COOR^{x}—, -halo-, -acryloyl-, -epoxy-, —SH—, —OH— or —CONR^{x}₂-substituted, Si—OC-bonded C₁₋₂₀-hydrocarboxy radical, in each of which one or more nonadjacent methylene units may be replaced by —O—, —CO—, —COO—, —OCO—or —OCOO—, —S— or —NR^{x}-groups and in which one or more nonadjacent methine units may be replaced by —N═, —N═N— or —P═ groups,
s has values of at least 1,
r has values of at least 1,
s+t has the value of r and
k+m+p+q have values of at least 2.

The cyclic silazanes of the general formula (III) used may be prepared by known processes in a simple manner and in high yields. In this regard, reference is made, for example, to EP-B1 1 195 379.

In the cyclic silazane of the general formula (III), R may be aliphatically saturated or unsaturated, aromatic, straight-chain or branched. R is preferably an unbranched C₃₋₆-alkylene radical which may be substituted by halogen atoms, especially fluorine and chlorine. Preferably 3 atoms are arranged between silicon atom and nitrogen atom of the ring.

The C₁₋₂₀-hydrocarbon radicals and C₁₋₂₀-hydrocarboxy radicals R¹ may be aliphatically saturated or unsaturated, aromatic, straight-chain or branched. R¹ is more preferably a straight-chain or branched hydrocarbon radical having from 1 to 6 carbon atoms, especially a methyl, ethyl, phenyl, vinyl and trifluoropropyl radical, most preferably the methyl radical.

Preference is given to preparing the compounds of the general formula (I) in which R is a propylene radical and R¹ is a methyl, ethyl, phenyl, vinyl or trifluoropropyl radical.

The amino-functional organosiloxane of the formula (I) prepared in accordance with the invention may be linear, cyclic or branched. The sum of k, m, p, q, s and t is preferably a number from 2 to 20,000, especially from 8 to 1000.

A preferred variant of a branched organosiloxane of the formula (I) is an organosiloxane resin. Such resins may consist of a plurality of units, as shown in formula (I), where the relative molar fractions of the units present are indicated by the indices k, m, p, q, s and t. In these resins, k+m must be >0. For the preparation of such a resin, preference is given to using an organosiloxane resin of the formula (II) in which from 0.1 to 20% of units r, based on the sum of k, m, p, q and r, are present and k+m>0. In the reaction of compound of the formula (II) with silazane of the formula (III), silanol groups are replaced by aminopropylsiloxy groups.

In the inventive reaction of compound of the formula (II) with silazane of the formula (III), preference is given to obtaining resins of the formula (I) in which 5 mol % <k+m<90 mol %, based on the sum of k, m, p, q, s and t, and t is preferably 0. In a particularly preferred case, the R radical is a propylene radical and R¹ is a methyl radical.

When the intention is to prepare resins which have only a defined amine content by the process according to the invention, the stoichiometric ratios between resin of the formula (II) and cyclic silazane are selected such that the desired amine content is attained. Residual Si—OH groups may optionally remain in the product.

A further preferred variant for an amino-functional organosiloxane of the formula (I) is a linear organosiloxane of the formula (IV)

[H]ᵤ[H₂N—R—SiR¹₂]ᵥO(SiR¹₂O)ₙSiR¹₂—R—NH₂ (IV),

which is prepared in accordance with the invention from organosiloxane(s) of the general formula

HO(R¹₂SiO)ₙR¹₂SiOH (V)

with cyclic silazane of the general formula (III) in the presence of Bronsted acids,
where
u is 0 or 1,
v is equal to 1-u and
n indicates the average degree of polymerization and is a number from 1 to 20,000.
u preferably has the value 0.
n preferably has values of from 1 to 10,000, in particular from 8 to 2000.

The linear organosiloxanes of the formula (IV) thus prepared can essentially be characterized by 3 different parameters:
viscosity (or molecular weight),
amine content and
degree of amino functionality of the end groups, i.e. the extent of the substitution of the silanol end groups in (V) by H₂N—R—SiR¹₂ groups.

However, only two of these parameters can be varied independently of one another in linear organosiloxanes of the formula (IV), i.e. the amine content is fixed for a fixed viscosity and functionality. In the case of a fixed amine content and viscosity, the functionality is fixed, and, in the case of a fixed amine content and functionality, the viscosity is fixed.

The compounds of the general formula (IV) prepared in accordance with the invention have the further advantage that they, when u>0, have condensable silanol end groups which can condense either with themselves or with compounds of the general formula (V), optionally with the support of a catalyst. It is possible in turn to obtain compounds of the general formula (IV) which then have a higher molecular weight. In a particularly preferred case, n is from 15 to 50 before the condensation and from 50 to 2000 after the condensation.

In the process according to the invention for preparing amino-functional organosiloxane of the formula (I), the amount of the silazanes of the formula (III) used is dependent upon the amount of the silanol groups to be functionalized in the compound of the formula (II) or (V). When, however, the intention is to achieve complete functionalization of the OH groups, the silazane should be added in at least equimolar amounts.

In the case of equimolar use, the removal of excess silazane can be dispensed with. To this end, the content of Si—OH groups in the silanol-terminated reactant is preferably determined, for example, by titration or NMR spectroscopy, in order thus to be able to add an at least equimolar amount of silazane.

When the cyclic silazane is used in excess in the process according to the invention, the unreacted silazane can either be distilled off thereafter or be hydrolyzed and then optionally drawn off, which is, however, not preferred.

Examples of Bronsted acids used as catalysts in the process according to the invention include hydrogen chloride, ammonium chloride, acidic ion exchange resins, ammonium formate, and alkylammonium formate. Likewise suitable as catalysts are chlorosilanes which, in the reaction with the silanol groups present in the compound of the formula (II) or (V) and/or the water present in traces, can release hydrogen chloride in a sufficient amount in situ.

The catalyst used in accordance with the invention is preferably hydrogen chloride, ammonium chloride and acidic ion exchange resins, particular preference being given to hydrogen chloride and ammonium chloride, especially ammonium chloride.

In the process according to the invention, Bronsted acids are preferably used in amounts of from 5 to 1000 ppm, more preferably from 10 to 500 ppm, especially from 50 to 300 ppm, based in each case on the total mass of the reaction mixture.

Preference is given to performing the process according to the invention at temperatures of from 0° C. to 100° C., more preferably at from 10° C. to 100° C., and in particular at from 40° C. to 100° C. The process is preferably performed at the pressure of the surrounding atmosphere, i.e. between 900 and 1100 hPa; but it is also possible, if desired, to work under reduced pressure or under elevated pressure. The process is preferably performed with exclusion of atmospheric moisture.

In the inventive process, all constituents may be mixed with one another as desired, and the process may be performed batchwise or continuously. The process may also be performed semicontinuously, for example when the components are mixed continuously and the complete reaction is effected batchwise.

The process may be performed either with inclusion of solvents or else without the use of solvents in suitable reactors. When solvents are used, preference is given to inert, especially aprotic, solvents such as aliphatic hydrocarbons, for example heptane or decane, and aromatic hydrocarbons, for example toluene or xylene. It is likewise possible to use ethers such as THF, diethyl ether or MTBE. If solvents are used, the amounts should preferably be sufficient to ensure sufficient homogenization of the reaction mixture. Solvents or solvent mixtures with a boiling point or boiling range of up to 180° C. at 0.1 MPa are preferred.

If silazane of the formula (III) is added to the organosiloxane of the formula (II) in less than stoichiometric amounts, residual unconverted Si—OH groups may remain in the amino-functional organosiloxane of the formula (I) or be reacted with other silazanes of the formula (VI) below:

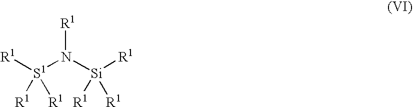

where R¹ may be the same or different and is defined as specified above, affording his affords amino-functional organosiloxane of the formula

(SiO_{4/2})ₖ(R¹SiO_{3/2})ₘ(R¹₂SiO_{2/2})ₚ(R¹₃SiO_{1/2})_{q}[O_{1/2}SiR¹₂—R—NH₂]ₛ[O_{1/2}H]ₜ(O_{1/2}SiR¹₃)_{w} (VII)

where R, R¹, k, m, p, q and s are each defined as specified above, t is greater than or equal to 0, w is greater than 0 and the sum of s+t+w=r and r is as defined in the above general formula (II).

Silazanes of the formula (VI) may be used simultaneously with cyclic silazane of the formula (III) or after the reaction of the silazane of the general formula (III).

When linear organosiloxanes of the above general formula (IV) are reacted with both silazanes of the general formula (III) and silazanes of the general formula (VI), this affords compounds of the general formula

[R¹₃Si]ᵤ[H²N—R—SiR¹₂]ᵥO(SiR¹₂O)ₙSiR¹₂—R—NH₂ (VIII)

where R¹, R and n are each as defined above, u and v are each 0 or 1 where u+v equals 1. This second termination can also optionally be dispensed with, but it offers significant advantages with regard to the stability of the materials at elevated temperatures, since Si—OH groups tend to condense at relatively high temperatures and thus increase the viscosity of the solutions obtained.

The components used in the process according to the invention may each be one type of such a component or a mixture of at least two types of a particular component.

The siloxanes prepared in accordance with the invention may be used for all purposes for which amino-functional siloxanes are useful. The process according to the invention has the advantage that it is simple to perform, and the further advantage that the products thus prepared can be processed further directly without removing the catalyst used. The amino-functional siloxanes can be prepared very selectively and in high yields.

In the examples which follow, all parts and percentage data, unless stated otherwise, are based on weight. Unless stated otherwise, the examples which follow are performed at a pressure of the surrounding atmosphere, i.e. at about 1000 hPa, and at room temperature, i.e. about 20° C. or a temperature which is established when the reactants are combined at room temperature without additional heating or cooling. All viscosity data given in the examples should relate to a temperature of 25° C. The amine number is determined in accordance with DIN 53176.

### COMPARATIVE EXAMPLE 1

1000 g of bishydroxy-terminated polydimethylsiloxane with a silanol content of 12,500 ppm and a water content of 1400 ppm were reacted with 102.5 g of N-((3-aminopropyl)dimethylsilyl)-2,2-dimethyl-1-aza-2-silacyclopentane. ¹H NMR and ²⁹Si NMR showed that, after 3 hours, 300 ppm of Si—OH groups still had not been converted to aminopropyl units and residual N-((3-aminopropyl)dimethylsilyl)-2,2-dimethyl-1-aza-2-silacyclopentane was still present. Subsequently, for the conversion of the remaining silazane, another 2 ml of water were added to the reaction solution and the mixture was distilled briefly at a pressure of 20 mbar at 60° C. The amine number is 48.8.

### EXAMPLE 1

1000 g of bishydroxy-terminated polydimethylsiloxane with a silanol content of 12,500 ppm and a water content of 1400 ppm were reacted with 102.5 g of N-((3-aminopropyl)dimethylsilyl)-2,2-dimethyl-1-aza-2-silacyclopentane and 100 ppm of ammonium chloride. ¹H NMR and ²⁹Si NMR measurements showed that, after 3 hours, all Si—OH groups had been converted to aminopropyl units and no residual N-((3-aminopropyl)dimethylsilyl)-2,2-dimethyl-1-aza-2-silacyclopentane was present. The amine number was 49.8.

### COMPARATIVE EXAMPLE 2

5.003 g of bishydroxy-terminated polydimethylsiloxane having a silanol content of 15,100 ppm and a water content of 1400 ppm was mixed with 0.5899 g (1.77% molar deficiency) of N-((3-aminopropyl)dimethylsilyl)-2,2-dimethyl-1-aza-2-silacyclopentane and heated at 80° C. From time to time, approx. 30 μl of sample are withdrawn, dissolved in CDCl₃ and analyzed with ¹H NMR. The results can be taken from Table 1. After 400 minutes, 685 ppm of Si—OH groups still had not been converted to aminopropyl units and residual N-((3-aminopropyl)dimethylsilyl)-2,2-dimethyl-1-aza-2-silacyclopentane was still present.

TABLE 1

| Time [min] | Mol % of silazane | [ppm] of SiOH | Mol % of SiOH |
|---|---|---|---|
| 21 | 3.84 | 9650 | 4.41 |
| 31 | 3.5 | 7747 | 3.54 |
| 42 | 3.07 | 6739 | 3.08 |
| 54 | 2.61 | 6215 | 2.84 |
| 75 | 2.23 | 5084 | 2.32 |
| 196 | 1.03 | 1930 | 0.88 |
| 319 | 0.59 | 1123 | 0.51 |
| 422 | 0.54 | 685 | 0.31 |

### EXAMPLE 2

5.0046 g of bishydroxy-terminated polydimethylsiloxane having a silanol content of 15,100 ppm and a water content of 1400 ppm were mixed with 0.5852 g (2.55% molar deficiency) of N-((3-aminopropyl)dimethylsilyl)-2,2-dimethyl-1-aza-2-silacyclopentane and 100 ppm of ammonium chloride and heated at 80° C. From time to time, approx. 30 μl of sample are withdrawn, dissolved in CDCl₃ and analyzed with ¹H NMR. The results can be taken from Table 2. After approx. 140 minutes, 1050 ppm of Si—OH groups still had not been converted to aminopropyl units but barely any residual N-((3-aminopropyl)dimethylsilyl)-2,2-dimethyl-1-aza-2-silacyclopentane was present.

TABLE 2

| Time [min] | Mol % of silazane | [ppm] of SiOH | Mol % of SiOH |
|---|---|---|---|
| 20 | 1.41 | 3240 | 1.48 |
| 31 | 0.71 | 1799 | 0.82 |
| 43 | 0.16 | 1509 | 0.69 |
| 55 | 0.11 | 1287 | 0.59 |
| 67 | 0.06 | 1190 | 0.54 |
| 78 | 0.04 | 1119 | 0.51 |
| 90 | 0.03 | 1101 | 0.5 |
| 103 | 0.02 | 1071 | 0.49 |
| 140 | 0.01 | 1054 | 0.48 |
| 210 | 0.01 | 1026 | 0.47 |
| 263 | 0.01 | 1030 | 0.47 |
| 334 | 0.01 | 1015 | 0.46 |

### COMPARATIVE EXAMPLE 3

40 g of bishydroxy-terminated polydimethylsiloxane with a silanol content of 13,300 ppm and a water content of 392 ppm were mixed with 3.8 g of N-((3-aminopropyl)dimethylsilyl)-2,2-dimethyl-1-aza-2-silacyclopentane and heated at 80° C. After 42 hours, no silanol was detectable any longer by NIR (Bruker-Optik IFS 66 FT-IR spectrometer with NIR module).

### EXAMPLE 3

50 mg of dichlorodimethylsilane (Me₂SiCl₂) are mixed with 100 g of N-((3-aminopropyl)dimethylsilyl)-2,2-dimethyl-1-aza-2-silacyclopentane. Two days thereafter, 40 g of bishydroxy-terminated polydimethylsiloxane with a silanol content of 13,300 ppm and a water content of 392 ppm were mixed with 3.8 g of the N-((3-aminopropyl)dimethylsilyl)-2,2-dimethyl-1-aza-2-silacyclopentane/Me₂SiCl₂ mixture and heated at 80° C. After 25 hours, no silanol was detectable any longer by NIR (Bruker-Optik IFS 66 FT-IR spectrometer with NIR module).

### COMPARATIVE EXAMPLE 4

950 kg of bishydroxy-terminated polydimethylsiloxane with a silanol content of 12,000 ppm and a water content of 250 ppm were reacted at 80° C. with 80.1 kg of N-((3-aminopropyl)dimethylsilyl)-2,2-dimethyl-1-aza-2-silacyclopentane. ¹H NMR and 29Si NMR showed that, after 4 hours, approx. 400 ppm of residual Si—OH groups were still present and approx. 3 mol % of residual N-((3-aminopropyl)dimethylsilyl)-2,2-dimethyl-1-aza-2-silacyclopentane was present.

### EXAMPLE 4

950 kg of bishydroxy-terminated polydimethylsiloxane with a silanol content of 12,000 ppm and a water content of 250 ppm (same charge as in comparative example 4) were reacted at 80° C. with 80.1 kg of N-((3-aminopropyl)dimethylsilyl)-2,2-dimethyl-1-aza-2-silacyclopentane and 100 g of ammonium chloride. ¹H NMR and 29Si NMR showed that, after 4 hours, only 20 ppm of residual Si—OH groups were still present and no residual N-((3-aminopropyl)dimethylsilyl)-2,2-dimethyl-1-aza-2-silacyclopentane was present.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for preparing amino-functional organosiloxanes of the formula
(SiO_{4/2})ₖ(R¹SiO_{3/2})ₘ(R¹₂SiO_{2/2})ₚ(R¹₃SiO_{1/2})_{q}[O_{1/2}SiR¹₂—R—NH₂]ₛ[O_{1/2}H]ₜ (I)
comprising reacting at least one organosiloxane of the general formula
(SiO_{4/2})ₖ(R¹SiO_{3/2})ₘ(R¹₂SiO_{2/2})ₚ(R¹₃SiO_{1/2})_{q}[O_{1/2}H]ₜ (II)
with at least one cyclic silazane of the general formula 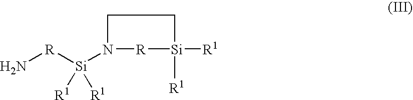
in the presence of Bronsted acids,
where
R are the same or different and are divalent Si—C— and C—N-bonded, optionally cyano- or halo-substituted C₃₋₁₅-hydrocarbon radicals in which one or more nonadjacent methylene units are optionally replaced by —O—, —CO—, —COO—, —OCO— or —OCOO—, —S— or —NR^{x}— groups and in which one or more nonadjacent methine units are optionally replaced by —N═, —N═N— or —P═ groups, where at least 3 and at most 6 atoms are between the silicon atom and the nitrogen atom of the ring,
R^{x} are the same or different and are hydrogen or an optionally —CN— or halogen-substituted C₁₋₁₀-hydrocarbon radical,
R¹ are the same or different and are hydrogen or a monovalent, optionally —CN—, —NCO—, —NR^{x}₂—, —COOH—, —COOR^{x}—, -halo-, -acryloyl-, -epoxy-, —SH—, —OH— or —CONR^{x}₂-substituted, Si—C-bonded C₁₋₂₀-hydrocarbon radical, or a monovalent, optionally —CN—, —NCO—, —NR^{x}₂—, —COOH—, —COOR^{x}—, -halo-, -acryloyl-, -epoxy-, —SH—, —OH— or —CONR^{x}₂-substituted, Si—OC-bonded C₁₋₂₀-hydrocarboxy radical, in each of which one or more nonadjacent methylene units are optionally replaced by —O—, —CO—, —COO—, —OCO—, —OCOO—, —S— or —NR^{x}-groups, and in which one or more nonadjacent methine units are optionally replaced by —N═, —N═N— or —P═ groups,
s is at least 1,
r is at least 1,
s+t has the value of r and
k+m+p+q is at least 2.

2. The process of claim 1, wherein R is an unbranched C₃₋₆-alkylene radical optionally substituted by halogen atoms.

3. The process of claim 1, wherein R¹ is a methyl, ethyl, phenyl, vinyl or trifluoropropyl radical.

4. The process of claim 2, wherein R¹ is a methyl, ethyl, phenyl, vinyl or trifluoropropyl radical.

5. The process of claim 1, wherein Bronsted acids are present in amounts of from 5 to 1000 ppm, based on the total mass of the reaction mixture.

6. The process of claim 1, wherein the Bronsted acid is ammonium chloride.

7. The process of claim 1, which is performed at from 0° C. to 100° C.
